(19) United States
(12) Patent Application Publication
(10) Pub. No.: US 2003/0197116 A1
(43) Pub. Date: Oct. 23, 2003

(54) Combination shutter and attenuator disk for an imaging apparatus

(75) Inventor: Christopher M. Downs, Canandaigua, NY (US)

Correspondence Address: PATENT LEGAL STAFF, EASTMAN KODAK COMPANY, 343 STATE STREET, ROCHESTER, NY, 14650-2201, US

(73) Assignee: David A. Novais, Eastman Kodak Company, Rochester, NY (US)

(21) Appl. No.: 10/063,395

(22) Filed: Apr. 18, 2002

(51) Int. Cl. G02B 5/00; G01D 5/32

(52) U.S. Cl. 250/229; 250/236; 250/505.1; 250/234

(57) ABSTRACT

A combination shutter and attenuator disk assembly for use in an imaging apparatus includes a circular disk that has a circular attenuation portion which surrounds a rotational axis of the disk, and circular shutter portion that surrounds the circular attenuating portion. The circular attenuation portion is divided into at least a variety of attenuating sections. The assembly also includes a movement device that includes a shutter cylinder for linearly moving the disk between shuttered and attenuated positions, and a rotatable motor that is adapted to rotate the disk to a desired attenuation section of the disk.

### BACKGROUND OF INVENTION

Conventional scanners and printers such as digital printers utilize the combination of a light source and optics to expose media or film. A conventional light source and optical arrangement for a printer or scanner is illustrated in FIG. 1. As shown in FIG. 1, the conventional arrangement includes a light source such as a lamp 6 and an optical assembly 18. Optical assembly 18 is utilized to focus light from a light source onto media for printing and/or exposure purposes depending on whether the apparatus is a scanner or printer. An optical path 20 having an optical axis is defined between light source 6 and optical assembly 18. As shown, a heat filter 8 and a color filter 10 can be located at optical path 20. Additionally, a shutter disk 12 for exposure purposes, and an attenuator disk 14 with an attenuator motor 16 for controlling the amount of light that is eventually passed to optical assembly 18is provided between light source 6 and optical assembly 18. In the conventional arrangement as illustrated in FIG. 1, shutter disk 12 and attenuator disk 14 are separate elements. By having separate elements for shutter disk 12 and attenuator disk 14, a length (represented by reference numeral 22) of optical path 20 is increased, which results in an imaging apparatus of increased size.

### SUMMARY OF INVENTION

The present invention relates to a combination shutter and attenuator disk that can be used for imaging apparatuses such as scanners or printers. The combination shutter and attenuator disk of the present invention is a single disk that can be controlled to alternatively attenuate and block light from a light source in an imaging apparatus.

The present invention provides for a unique arrangement in which the shutter and attenuator disk are combined as a single unit to reduce the space between a light source and an optical assembly. The combined shutter and attenuator disk of the present invention can be moved toward and away from an optical axis of an optical path by way of, for example, a shutter cylinder, and can be rotated or indexed to a desired attenuation position by a motor.

When total darkness is required in a rapid manner, rather than rotating a disk to a shuttered position, the shutter cylinder of the present invention can linearly shift the combination shutter and attenuator disk to a shutter portion area of the disk. This permits a return to a desired attenuation level by linearly moving the disk back to an attenuation position without losing a desired calibrated attenuation position.

The present invention relates to a combination shutter and attenuator disk assembly for use in an imaging apparatus which comprises a circular disk that includes a circular attenuating portion that surrounds a rotational axis of the disk. The circular attenuating portion is divided into at least a first light attenuating section which provides a first amount of light attenuation when the first light attenuation section is placed at an optical path of a light source, and a second light attenuation section which provides a second amount of light attenuation which is different from the first amount of light attenuation when the second light attenuating section is placed at the optical path of the light source. The circular disk further includes a circular shutter portion that surrounds the circular attenuating portion. The circular shutter portion blocks light from the light source when the circular shutter portion is placed at the optical path.

The present invention further relates to a combination shutter and attenuator disk assembly for use in an imaging apparatus which comprises a circular disk that includes attenuation means for providing at least a first and a second amount of light attenuation for light from a light source; a shutter means for blocking the light from the light source; first moving means for moving the circular disk between a first position in which the attenuation means is at an optical path of an optical assembly, and a second position in which the shutter means is at the optical path; and second moving means for rotating the circular disk to a desired attenuation position when the circular disk is in the first position.

The present invention further relates to a combination shutter and attenuator disk for use in an imaging apparatus which comprises a circular attenuation portion that surrounds a rotational axis of the disk, with the circular attenuation portion comprising a plurality of attenuating sections having different light attenuating properties; and a circular shutter portion that surrounds the circulator attenuating portion and is adapted to block light.

The present invention further relates to a method of alternatively attenuating and blocking light from a light source in an imaging apparatus. The method comprises the steps of linearly moving a circular disk having a plurality of attenuating sections with different light attenuating properties to an attenuating position in which one of the attenuating sections is at an optical path of an optical assembly and a light source, with the circular disk further comprising a shutter portion that surrounds the attenuating sections; rotating the circular disk until a desired one of the attenuating sections is aligned with the optical path to provide for a desired amount of light attenuation; and linearly moving the circular disk between the attenuating position and a shuttering position in which the shutter portion of the circular disk is at the optical path to block light from the light source.

The present invention further relates to an imaging apparatus that comprises a light source; an optical system having an optical axis, which extends along an optical path with the optical system focusing light from the light source; and a combination shutter and attenuator disk positioned between the light source and the optical system. The combination shutter and attenuator disk comprises a circular attenuating portion that surrounds a rotational axis of the disk, with the circular attenuating portion comprising a plurality of attenuating sections having different light and attenuating properties for attenuating light from the light source; and a circular shutter portion that surrounds the circular attenuating portion and is adapted to block light from the light source.

The present invention further relates to a combination shutter and attenuator disk assembly for use in an imaging apparatus which comprises a circular disk that includes a circular attenuating portion, with the circular attenuating portion being divided into at least a first light attenuating section which provides a first amount of light attenuation when the first light attenuating section is placed at an optical path of a light source, and a second light attenuating section which provides a second amount of light attenuation which is different from the first amount of light attenuation when the second light attenuating section is placed at the optical path of the light source. The circular disk further includes a circular shutter portion which blocks light from the light source when the circular shutter portion is placed at the optical path.

### BRIEF DESCRIPTION OF DRAWINGS

FIG. 1 illustrates a conventional arrangement which includes a shutter disk and an attenuator disk provided in an optical system of a scanner or printer;

FIG. 2 illustrates a combination shutter and attenuator disk assembly in accordance with the present invention, provided within an optical system of an imaging apparatus such as a scanner or printer;

FIG. 3 illustrates the combination shutter and attenuator disk assembly of the present invention detailing the attenuating sections of the shutter and attenuator disk, as well as showing the combination shutter and attenuator disk in a position in which the attenuating portion is at the optical path of the optical system; and

FIG. 4 is a view of the combination shutter and attenuator disk of the present invention similar to FIG. 3, but showing the combination shutter and attenuator disk in a position in which the shuttering portion of the combination shutter and attenuating disk is at the optical path.

### DETAILED DESCRIPTION

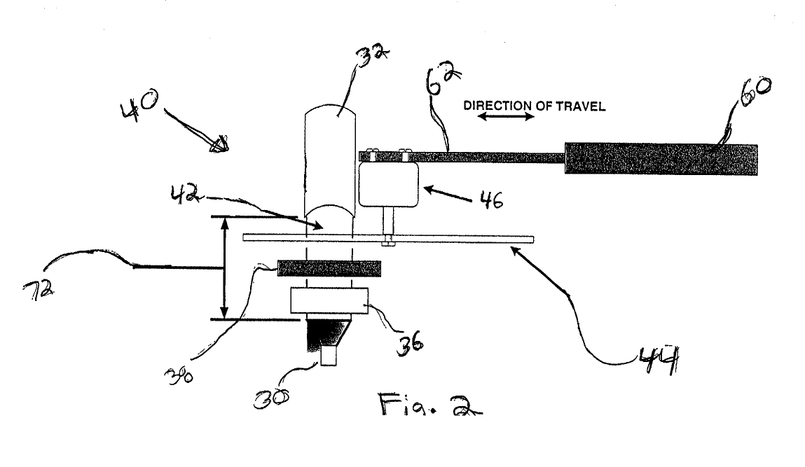

Referring now to the drawings, wherein like reference numerals represent identical or corresponding parts throughout the several views, FIG. 2 illustrates an imaging section 40 of an imaging apparatus such as a scanner or printer in accordance with the present invention. Imaging section 40 includes a light source 30 and optionally a first filter 32 such as a heat filter and a second filter 38 such as a color filter. The filters are used to illuminate and or moderate portions of light being transmitted from light source 30. Color filter 38 can be a known color filter such as a color filter wheel that is used to form a color image on, for example, a photosensitive paper. Imaging section 40 further includes an optical assembly 32 such that an optical path 42 having an optical axis is formed between light source 30 and optical assembly 32. Optical assembly 32 is used to focus light onto, for example, a photographic paper or a sensor.

Imaging section 40 further includes a shutter/attenuator disk 44 which is provided between optical assembly 32 and filter 38, and is designed to extend into optical path 42.

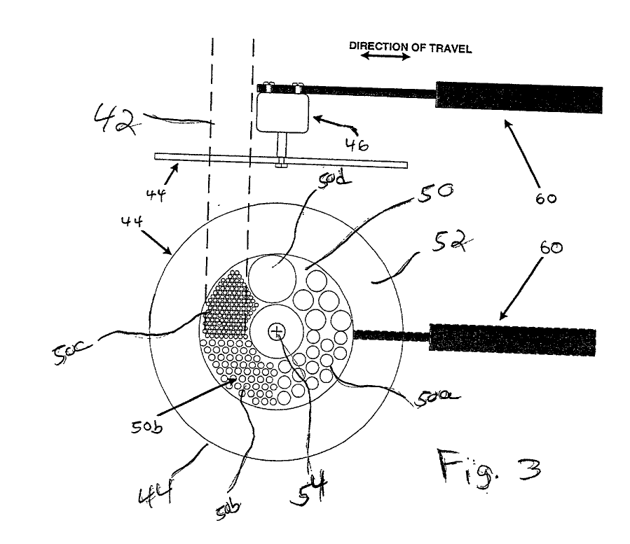

The specific structure of shutter/attenuator disk 44 is illustrated in FIG. 3 which is a view of the imaging section 40 of FIG. 2, however, in FIG. 3, a top view of shutter/attenuator disk 44 is shown to illustrate the different portions and sections of shutter/attenuator disk 44.

More specifically, as shown in FIG. 3, shutter/attenuator disk 44 is preferably a circular disk that includes a circular attenuating portion 50 that surrounds a rotational axis 54 of disk 44. Circular attenuating portion 50 preferably includes a plurality of attenuating sections 50a, 50b, and 50c, which each provide different levels of light attenuation from light source 30. More specifically, as shown in FIG. 3, a first light attenuation section 50a which includes a plurality of larger holes, lets more light from light source 30 pass onto optical assembly 32, while second and third attenuating sections 50b and 50c, which include smaller holes, would each allow a decreased amount of light to go from light source 30 to optical assembly 32.

Attenuating portion 50 further includes a section 50d which can be defined as a zero attenuation section or a non-attenuating section that lets all light pass therethrough. Non-attenuating section 50d can be in the form of a large circular hole which essentially lets all of the light from light source 30 pass to optical assembly 32.

Shutter/attenuator disk 44 further includes a circular shutter portion 52 that surrounds circular attenuating portion 50. Circular shutter portion 52 is basically a solid surface which is designed to block light from light source 30 from reaching optical assembly 32 when shutter/attenuator disk 44 is provided in a blocking position with respect to light source 30.

In a feature of the present invention, shutter/attenuator disk 44 is controllably rotated and linearly movable so as to selectively or alternatively attenuate or block light from light source 30. For this purpose, and as shown in FIGS. 2 and 3, imaging section 40 includes a moving arrangement or apparatus which comprises a shutter cylinder 60 and a motor 46. Shutter cylinder 60 includes a piston 62, and is adapted to move shutter/attenuator disk 44 in a linear manner in a direction perpendicular to optical path 42.

More specifically, imaging arrangement 40 includes a movement apparatus that comprises shutter cylinder 60 such as an air cylinder or a hydraulic cylinder that moves piston 62. Attached onto piston 62 is attenuator motor 46 that is coupled to shutter/attenuator disk 44. Attenuator motor 46 is used to rotate shutter/attenuator disk 44 so as to align the proper or desired attenuating section 50a. 50b, 50c, 50d with optical path 42.

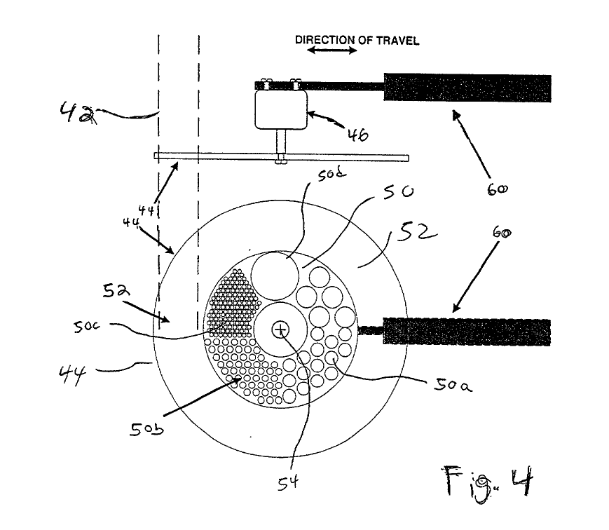

Therefore, shutter cylinder 60 is adapted to move shutter/attenuator disk 44 between an attenuating position as illustrated in FIG. 3 where one of the attenuator sections 50a 50d is aligned with optical path 42, or is aligned with the optical axis for optical path 42; and a shutter position as illustrated in FIG. 4 in which shuttering portion 52 is aligned with optical path 42, or is aligned with the optical axis for optical path 42. Attenuator motor 46 is adapted to rotate shutter/attenuator disk 44 so as to align the proper attenuating section 50a 50d with optical path 42.

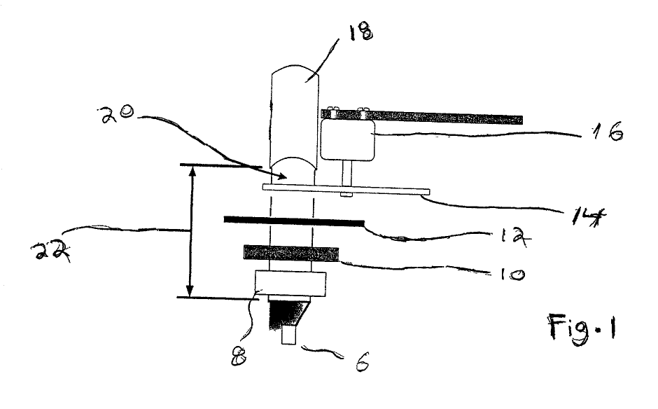

With the arrangement of the present invention as illustrated in FIG. 2, a length (represented by reference numeral 72) of optical path 42 is decreased as compared to optical path 20 in FIG. 1. More specifically, length 72 of optical path 42 in accordance with the present invention is reduced from length 22 shown in FIG. 1. This is due to the fact that with the arrangement of the present invention, the shutter and attenuator functions are provided on a single disk as opposed to separate elements.

During use of a shutter/attenuator disk arrangement in accordance with the present invention, shutter/attenuator disk 44 is linearly moved by shutter cylinder 60 to an attenuator position in which attenuating portion 50 (FIG. 3) is at optical path 42. At that point or prior to this, attenuator motor 46 is operated so as to align the proper attenuating section 50a 50d with optical path 42. In the example of FIG. 3, attenuating section 50c is aligned with optical path 42. Therefore, in the example of FIG. 3, it is desired to attenuate light from light source 30 by an amount proportional to the attenuation provided by attenuating section 50c. When it is desired to block light from light source 30 during an exposure operation, shutter cylinder 60 is activated to linearly move shutter/attenuator disk 44 to a shutter position as illustrated in FIG. 4, such that shutter portion 52 is aligned with optical path 42. In this arrangement, light from light source 30 is blocked by shutter portion 52. When it is again desired to provide for light attenuation, a user simply has to operate shutter cylinder 60 to move shutter/attenuator disk 44 back to the attenuator position illustrated in FIG. 3, so that attenuating section 50c is aligned with optical path 42. An advantage of this arrangement is that shutter/attenuator disk 44 is calibrated to attenuating section 50c. More specifically, simply by reciprocating shutter/attenuator disk 44 back and forth between the positions illustrated in FIGS. 3 and 4, you can provide for exposure with a desired attenuation value and a non-exposure; and more specifically, a blocking and a desired attenuation of light. The arrangement of the present invention permits this shifting between shuttered and attenuated states without the necessity of rotating shutter/attenuator disk 44. The advantage of this arrangement is that you do not lose your calibrated position by having to rotate shutter/attenuator disk 44 back to a desired attenuator position. In the present invention, the desired attenuating position is maintained while the shutter/attenuator disk 44 is linearly moved between the shuttered and attenuated positions.

Of course, FIG. 3 only shows a single example and it is recognized that when shutter/attenuator disk 44 is in the attenuating position of FIG. 3, any of the attenuating sections 50a 50d can be aligned with optical path 42, and thereafter, the assembly can be utilized as described above by reciprocating the shutter/attenuator disk 44 between shuttered and attenuated positions as illustrated in FIGS. 3 and 4.

As noted above, the present invention can be used in imaging apparatuses such as printers and scanners when it is desired to focus an optical light from a light source onto media or a CCD. A further example for using the arrangement of the present invention is as a calibrating tool. More specifically, when it is desired to calibrate the amount of light applied to, for example, a media or a sensor, the shutter/attenuator disk 44 can be moved to optical path 42 as illustrated in FIG. 3, so that one of attenuating sections 50a-50d is aligned with optical path 42. At this point, shutter/attenuator disk 4⁴ can be rotated so that the zero attenuation section 50d is provided at optical path 42. This permits light from light source 30 to pass onto, for example, a sensor without being attenuated. The sensor can thereby be used to calibrate the amount of light from light source 30. Thereafter, the shutter/attenuator disk 44 can be rotated to an appropriate attenuating section 50a 50c based on the result of the above-noted calibration.

Although a motor and shutter cylinder are shown with respect to the moving arrangement, the present invention is not limited thereto. For example, any kind of arrangement which provides for a linear motion can be used in place of shutter cylinder 60, and further, any type of movement device which can achieve a rotation of shutter/actuator disk 44 can also be utilized. Further, attenuating sections 50a 50d are shown as an example, and it is realized that the size and the number of holes within the respective attenuating sections can be modified based on the requirements of the imaging apparatus. Additionally, the positioning of attenuating portion 50 closer to rotational axis 54 can be reversed within the context of the present invention, such that shutter portion 52 could be closer to rotational axis 34 and attenuation portion 50 could be at the periphery of shutter/attenuator disk 44.

Accordingly, the present invention provides for a combination shutter and attenuator disk assembly that can be used in an imaging apparatus such as a printer or a scanner. The shutter/attenuator disk of the present invention combines both a shutter function and an attenuator function into a single disk so as to limit the amount of space required between a light source and an optical arrangement. The shutter/attenuator disk of the present invention can be driven by a motor and indexed or rotated to an amount of attenuation desired. When light blockage is required, rather than indexing to a shutter position, the present invention provides for a cylinder to shift the disk to an area on the disk that has no holes or attenuating sections. This permits a return to a desired attenuation level by simply shifting the attenuator disk back to the shutter position.

The invention has been described in detail with particular reference to certain preferred embodiments thereof, but it will be understood that variations and modifications can be effected within the spirit and scope of the invention.

1. The invention has been described in detail with particular reference to certain preferred embodiments thereof, but it will be understood that variations and modifications can be effected within the spirit and scope of the invention.
a circular disk which includes a circular attenuating portion that surrounds a rotational axis of the disk, said circular attenuating portion being divided into at least a first light attenuating section which provides a first amount of light attenuation when the first light attenuating section is placed at an optical path of a light source, and a second light attenuating section which provides a second amount of light attenuation which is different from the first amount of light attenuation when the second light attenuating section is placed at said optical path of the light source;
said circular disk further including a circular shutter portion which surrounds said circular attenuating portion, said shutter circular shutter portion blocking light from said light source when the circular shutter portion is placed at said optical path.

2. A disk assembly according to claim 1, further comprising:
a motor for rotating the circular disk around said rotational axis; and
a linear movement cylinder adapted to move the circular disk in a direction perpendicular to the optical path, said linear movement cylinder moving the disk between an attenuator position in which one of said first or second light attenuating sections is at said optical path and a shuttered position in which said circular shutter portion is at said optical path;
wherein:
said motor is adapted to rotate said circular disk to a desired attenuator position in which one of said first or second light attenuating sections is at said optical path when said circular disk is at said attenuator position, and said linear movement cylinder is adapted to move said disk between the shuttered position and said desired attenuator position.

3. A disk assembly according to claim 1, wherein said first light attenuating section comprises a plurality of first holes having a first size and said second light attenuating section comprises a plurality of second holes having a second size which is greater than said first size.

4. A disk assembly according to claim 1, wherein said attenuating portion further comprises a third attenuating section and a fourth section which defines an unattenuated section, a first one of said first to fourth sections comprising a plurality of first holes having a first size, a second one of said first to fourth sections comprising a plurality of second holes having a second size, a third one of said first to fourth sections comprising a plurality of third holes having a third size, and a fourth one of said first to fourth sections comprising a single hole which is sized to allow all the light from the light source to pass therethrough.

5. A combination shutter and attenuator disk assembly for use in an imaging apparatus, the disk assembly comprising:
a circular disk which includes attenuation means for providing at least a first and a second amount of light attenuation for light from a light source, and a shutter means for blocking the light from the light source;
first moving means for moving said circular disk between a first position in which said attenuation means is at an optical path of an optical assembly, and a second position in which said shutter means is at said optical path; and
second moving means for rotating said circular disk to a desired attenuation position when said circular disk is in said first position.

6. A combination shutter and attenuator disk for use in an imaging apparatus, the disk comprising:
a circular attenuating portion that surrounds a rotational axis of the disk, said circular attenuating portion comprising a plurality of attenuating sections having different light attenuating properties; and
a circular shutter portion which surrounds said circular attenuating portion and is adapted to block light.

7. A disk according to claim 6, wherein each of said attenuating sections comprise holes of varying sizes and said shutter portion comprises a solid surface which surrounds said holes of said attenuating portion.

8. A method of alternatively attenuating and blocking light from a light source in an imaging apparatus, the method comprising the steps of:
linearly moving a circular disk having a plurality of attenuating sections with different light attenuating properties to an attenuating position in which one of the attenuating sections is at an optical path of an optical assembly and a light source, said circular disk further comprising a shutter portion which surrounds said attenuating sections;
rotating the circular disk until a desired one of said attenuating sections is aligned with said optical path to provide for a desired amount of light attenuation; and
linearly moving the circular disk between said attenuating position and a shuttering position in which the shutter portion of said circular disk is at said optical path to block light from the light source.

9. An imaging apparatus comprising:
a light source;
an optical system having an optical axis which extends along an optical path, said optical system focusing light from said light source; and
a combination shutter and attenuator disk positioned between said light source and said optical system, said combination shutter and attenuator disk comprising:
a circular attenuating portion that surrounds a rotational axis of the disk, said circular attenuating portion comprising a plurality of attenuating sections having different light attenuating properties for attenuating light from said light source; and
a circular shutter portion which surrounds said circular attenuating portion and is adapted to block light from said light source.

10. An imaging apparatus according to claim 9, further comprising:
a motor for rotating the disk around said rotational axis; and
a linear movement cylinder adapted to move the disk in a direction perpendicular to the optical axis, said linear movement cylinder moving the disk between an attenuator position in which one of said plurality of attenuating sections is at said optical path and a shuttered position in which said circular shutter portion is at said optical path;
wherein:
said motor is adapted to rotate said disk to a desired attenuator position in which a desired one of said attenuating sections is at said optical path when said circular disk is at said attenuator position, and said linear movement cylinder is adapted to move said disk between the shuttered position and said attenuator position.

11. An imaging apparatus according to claim 9, wherein each of said attenuating sections comprise holes of varying sizes and said shutter portion comprises a solid surface which surrounds said holes of said attenuating portion.

12. An imaging apparatus according to claim 9, wherein said imaging apparatus is a printer.

13. An imaging apparatus according to claim 9, wherein said imaging apparatus is a scanner.

14. An imaging apparatus according to claim 9, wherein said shutter cylinder is an air cylinder.

15. A combination shutter and attenuator disk assembly for use in an imaging apparatus, the disk assembly comprising:
a circular disk which includes a circular attenuating portion, said circular attenuating portion being divided into at least a first light attenuating section which provides a first amount of light attenuation when the first light attenuating section is placed at an optical path of a light source, and a second light attenuating section which provides a second amount of light attenuation which is different from the first amount of light attenuation when the second light attenuating section is placed at said optical path of the light source;
said circular disk further including a circular shutter portion, said shutter circular shutter portion blocking light from said light source when the circular shutter portion is placed at said optical path.
